(19) United States
(12) Patent Application Publication
(10) Pub. No.: US 2009/0018784 A1
(43) Pub. Date: Jan. 15, 2009

(54) METHOD OF ESTIMATION OF THE PRESSURE DROP BETWEEN TWO SECTIONS OF THE EXHAUST LINE OF AN INTERNAL COMBUSTION ENGINE

(75) Inventors: Maura DINTINO, Torino (IT); Tommaso DE FAZIO, Torino (IT); Giovanni ROVATTI, Chieri (IT)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/171,145

(22) Filed: Jul. 10, 2008

(30) Foreign Application Priority Data
Jul. 12, 2007 (IT) RM2007A385

(51) Int. Cl. G01N 11/00

(52) U.S. Cl. 702/50

(57) ABSTRACT

A method is provided for estimating a pressure drop (Δp) between two sections of an exhaust line of an engine, such as a diesel engine. The method includes, but is not limited to the steps of measuring a fresh air flow rate (\dot{m}ₐ) into the engine, measuring a fuel flow rate (\dot{m}_{f}) into the engine, calculating an exhaust gas flow rate (\dot{M}) from the fresh air and fuel flow rates (\dot{m}ₐ, \dot{m}_{f}), determining an estimated pressure drop (□p) as a function of the exhaust gas flow rate (\dot{M}), characterized in that the exhaust gas flow rate (\dot{M}) is calculated as a weighted sum of the fresh air and fuel flow rates (\dot{m}ₐ, \dot{m}_{f}) wherein a weighting factor (k) of the fuel flow rate (\dot{m}_{f}) is higher than a weighting factor of the fresh air flow rate (\dot{m}ₐ).

### CROSS-REFERENCE TO RELATED APPLICATION

This application claims priority to Italian Patent Application No. RM2007A385, filed Jul. 12, 2007, which is incorporated herein by reference in its entirety.

### TECHNICAL FIELD

The present invention generally relates to a method for estimating a pressure drop between two sections of an exhaust line of a diesel engine.

### BACKGROUND

It is known that the pressure drop between any two sections of a fluid line is mainly a function of the mass flow rate of the fluid circulating in it. In case of an exhaust line, it is not convenient to measure directly the exhaust mass flow, but in most control strategies for diesel engines flow rates of fresh air and of fuel supplied to the engine are known, so that the exhaust gas mass flow can easily be calculated from these. Accordingly, it is suggested in EP 1 081 347 B1, for example, to estimate a pressure at a downstream side of a particulate filter using a function f(W_{DPF}, T_{b}) of exhaust gas flow rate W_{DPF} and exhaust gas temperature T_{b}, where W_{DPF} is the sum of fresh air flow rate and fuel flow rate.

The function f is a polynomial, the coefficients of which are identified from experimental data. This method is rather tedious to implement, since a large quantity of experimental data is necessary to fit the polynomial f in the two variables W_{DPF}, T_{b}. Further for estimating the pressure Pb downstream of the particulate filter, the temperature T_{b} at the downstream side of the filter has to be known. So, either a sensor must be provided for measuring T_{b}, or a mathematical model must be developed for calculating it.

In view of the foregoing, it is at least one object to provide a method for estimating a pressure drop between two sections of an exhaust line of a diesel engine which is easier and quicker to implement than conventional methods. In addition, other objects, desirable features, and characteristics will become apparent from the subsequent summary and detailed description and the appended claims, taken in conjunction with the accompanying drawings and this background.

### SUMMARY

The at least one object, other objects, desirable features, and characteristics, is achieved by a method comprising the steps of measuring a fresh air flow rate into the engine, measuring a fuel flow rate into the engine, calculating an exhaust gas flow rate from the fresh air and fuel flow rates, and determining an estimated pressure drop as a function of the exhaust gas flow rate, which is characterized in that the exhaust gas flow rate is calculated as a weighted sum of the fresh air and fuel flow rates, and a weighting factor of the fuel flow rate is higher than a weighting factor of the fresh air flow rate.

It appears that using such a weighting factor, temperature dependency of the pressure drop can be taken account of in a very simple and straightforward fashion.

Experiments have shown that the weighting factor of the fuel flow rate should be at least twice that of the fresh air flow rate, and that it should preferably be in a range between about 5 and 30 times that of the fresh air flow rate.

The function yielding the pressure drop preferably is a polynomial in the exhaust gas flow rate, and it may have the exhaust gas flow rate as its only variable.

If the method is applied to an exhaust line and one of the sections comprises a pressure sensor and the other section comprises a second sensor which gives pressure dependent readings, the method preferably further comprises the steps of calculating a pressure in the other section based on a pressure reading from the pressure sensor and the estimated pressure drop, and of compensating a reading from the second sensor based on the calculated pressure. Such a second sensor can be an oxygen sensor, for example.

Alternatively, one of the sections may be a downstream end of the exhaust line. Since the downstream end is necessarily always at ambient pressure, it is possible to calculate the pressure in any other section of the exhaust line without having to use a pressure sensor.

### BRIEF DESCRIPTION OF THE DRAWINGS

The present invention will hereinafter be described in conjunction with the following drawing figures, wherein like numerals denote like elements, and

FIG. 1 is a schematic diagram of an exhaust system of a diesel engine;

FIG. 2 is a graph of the correlation coefficient between exhaust flow rate and pressure drop; and

FIG. 3 is a graph of measured and estimated pressure drops as a function of the exhaust gas flow rate.

### DETAILED DESCRIPTION

The following detailed description is merely exemplary in nature and is not intended to limit application and uses. Furthermore, there is no intention to be bound by any theory presented in the preceding background or the following detailed description.

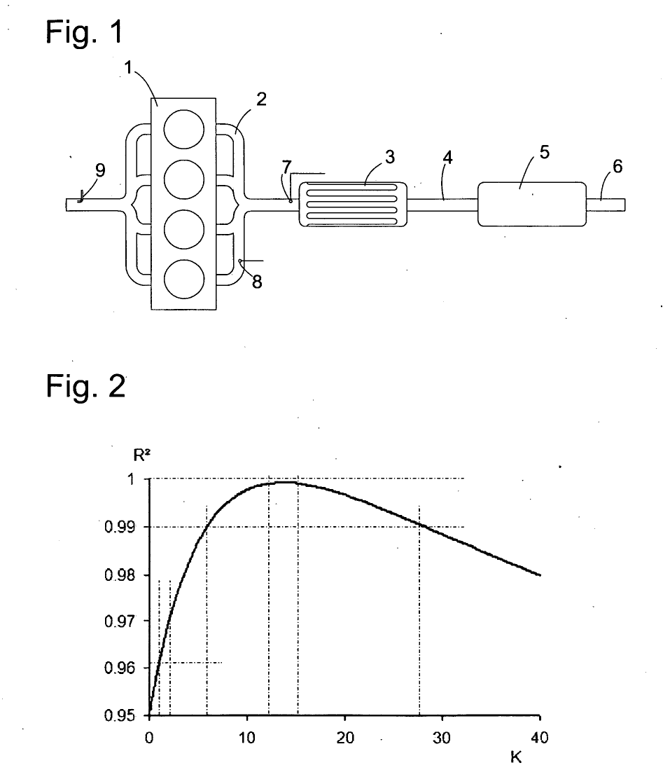

FIG. 1 shows schematically an engine block 1 of an engine, such as a diesel engine, having four cylinders, an exhaust manifold 2 for connecting each cylinder of the engine block to a particulate filter 3, a muffler 5, an exhaust duct 4 extending between the particulate filter 3 and the muffler 5, and an outlet section 6. When the engine is operating, and exhaust gas is flowing through the exhaust system of FIG. 1, a pressure drop occurs in any of its components, so that the pressure to which is exposed, such as an oxygen sensor 7, adjacent to an inlet of particulate filter 3 may be different from a pressure measured by a pressure sensor 8 in a upstream portion of the exhaust manifold 2, and the pressure drop to which is subject the particulate filter 3 is different from the difference between the pressure detected by sensor 8 and the ambient pressure.

In order to estimate a pressure drop between any two points of the exhaust system or between a given point of the exhaust system and the outside environment, the mass flow through the exhaust system must be known. Conventionally, an airflow sensor 9 is provided in the intake manifold of the engine for detecting the fresh air flow into the cylinders, and the fuel supplied to the cylinders is metered and is thus known, too. vIt can therefore be concluded that the mass flow rate me of the exhaust gas expelled from the engine block 1 should be the sum \dot{m}ₑ=\dot{m}ₐ+\dot{m}_{f} of fresh air flow rate \dot{m}ₐ and fuel flow rate \dot{m}_{f}. vIt is found, however, that based on a thus calculated exhaust gas flow rate, a completely reliable prediction of a pressure drop in the exhaust system is not possible. This is not so surprising, because it is known that the pressure drop depends not only on the mass flow rate, but also on the temperature of the flowing gas, and this temperature may vary according to the operating conditions of the engine. Surprisingly, however, it was found that this influence can be taken account of by replacing the above algebraic mass flow by a weighted mass flow M given by \dot{M}=\dot{m}ₐ+k\dot{m}_{f}, where k is a positive constant.

FIG. 2 is a graph of correlation coefficient R² obtained between measured and estimated pressure drops in the exhaust system of FIG. 1 as a function of the weighting coefficient k. In this graph, the algebraic mass flow \dot{m}ₑ corresponds to a weighting coefficient k=1. For this weighting coefficient, a correlation coefficient between measured and estimated pressure drops of slightly better than 0.96 is obtained. With a weighting coefficient k=2, the correlation coefficient becomes better than 0.97. In a range of about 6<k<28, the correlation is better than 0.99, and for about 12<k<15 it is nearly perfect at >0.998. It is immediately apparent that any temperature and/or load dependencies of the pressure drop in the exhaust system can be taken account of perfectly by choosing an appropriate value of the weighting coefficient k.

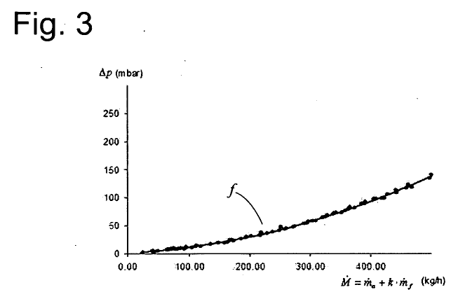

FIG. 3 illustrates the relation Δp=f(\dot{M}) between pressure drop Δp and weighted mass flow \dot{M} in a practical operating range of the engine. In this graph, dots represent measured values, and a curve f gives the estimated relationship between weighted mass flow \dot{M} and pressure drop. The agreement between estimate and experimental data is practically perfect. The curve f of FIG. 3 is a second order polynomial that can be obtained by least-squares-fitting, for example, to the experimental data.

The optimum value of the weighting coefficient k may depend to a certain extent on the characteristics of the engine. However, the optimum weighting coefficient for a given engine may be obtained quite straightforwardly by obtaining experimental data of pressure drop Δp, fresh air flow rate \dot{m}ₐ and fuel flow rate \dot{m}_{f}, and carrying out a least-squares fit for polynomial coefficients a₂, a₁ and weighting factor k in formula Δp=a₂(\dot{m}ₐ+k\dot{m}_{f})²+a₁(\dot{m}ₐ+k\dot{m}_{f}).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing detailed description will provide those skilled in the art with a convenient road map for implementing an exemplary embodiment it being understood that various changes may be made in the function and arrangement of elements described in an exemplary embodiment without departing from the scope set forth in the appended claims and their legal equivalents.

What is claimed is:

1. A method for estimating a pressure drop (Δp) between at least two sections of an exhaust line of an engine, comprising the steps of:
measuring a fresh air flow rate (\dot{m}ₐ) into the engine;
measuring a fuel flow rate (\dot{m}_{f}) into the engine;
calculating an exhaust gas flow rate (\dot{M}) from said fresh air flow rate (\dot{m}ₐ) and said fuel flow rate (\dot{m}_{f}); and
determining an estimated pressure drop (Δp) as a function of said exhaust gas flow rate (\dot{M}),
wherein the exhaust gas flow rate (\dot{M}) is calculated as a weighted sum of said fresh air flow rate (\dot{m}ₐ) and said fuel flow rate (\dot{m}_{f}), and
wherein a weighting factor (k) of the fuel flow rate (\dot{m}_{f}) is higher than a weighting factor of the fresh air flow rate (\dot{m}ₐ).

2. The method of claim 1, wherein the weighting factor (k) of the fuel flow rate (\dot{m}_{f}) is at least twice that of the fresh air flow rate (\dot{m}ₐ).

3. The method of claim 1, wherein the weighting factor of the fuel flow rate (\dot{m}_{f}) is between about 5 and 30 times that of the fresh air flow rate (\dot{m}ₐ).

4. The method of claim 1, wherein the function (ƒ) yielding the pressure drop (Δp) is a polynomial in the exhaust gas flow rate (\dot{M}).

5. The method of claim 1, wherein one of said at least two sections comprises a pressure sensor and the other section comprises a second sensor that measures pressure-dependent readings, said method further comprising the steps of calculating a pressure in said other section based on a pressure reading from said pressure sensor and said estimated pressure drop, and of compensating a reading from said second sensor based on the calculated pressure.

6. The method of any of claim 1, wherein one of said sections is a downstream end of the exhaust line.
